(19) United States
(12) Patent Application Publication
(10) Pub. No.: US 2007/0243456 A1
(43) Pub. Date: Oct. 18, 2007

(54) Thread-Type Flexible Battery

(75) Inventors: Hyo-Jun Ahn, Gyeongsangnam-do (KR); Ki-Won Kim, Gyeongsangnam-do (KR); Tae-Hyun Nam, Gyeongsangnam-do (KR); Hwi-Beom Shin, Gyeongsangnam-do (KR); Hyun-Chil Busan, Busan (KR); Jai-Young Lee, Daejeon (KR); Ho-Suk Ryu, Gyeongsangnam-do (KR); Dong-Hyun Ryu, Jeollanam-do (KR); Sang-Won Lee, Gyeongsangnam-do (KR); Tae-Bum Kim, Busan (KR); Sang-Sik Jeong, Gyeongsangnam-do (KR); Byung-Soo Jung, Gyeongsangnam-do (KR); Jong-Hwa Kim, Gyeongsangnam-do (KR); Duck-Jun Lee, Gyeongsangnam-do (KR); Young-Jin Choi, Gyeongsangnam-do (KR); Jou-Hyeon Ahn, Gyeongsangnam-do (KR); Jin-Kyu Kim, Gyeongsangnam-do (KR); Jae-Won Choi, Gyeongsangnam-do (KR); Yeon-Hwa Kim, Gyeongsangnam-do (KR); Jong-Uk Kim, Jeollabuk-do (KR)

Correspondence Address: BIRCH STEWART KOLASCH & BIRCH, PO BOX 747, FALLS CHURCH, VA, 22040-0747, US

(73) Assignee: Gyeongsang National University, Gyeongsangnam-do (KR)

(21) Appl. No.: 11/578,045

(22) PCT Filed: May 17, 2004
(86) PCT No.: PCT/KR04/01167

§ 371 Date: Feb. 9, 2007

(30) Foreign Application Priority Data
Apr. 12, 2004 (KR) 10-2004-0025127

(51) Int. Cl. H01M 2/10

(52) U.S. Cl. 429/94

(57) ABSTRACT

The present invention relates to a thread-type flexible battery, more precisely a thread-type flexible battery that can be transformed into various forms in necessary and easily connected to an instrument from outside thereof by having a shape of a thread, which is constructed by forming an inside electrode by coating electrode material at periphery side of inside current collector, and coating electrolyte at the outside of said inside electrode, and forming an outside electrode by coating electrode material at periphery side of said electrolyte, and then depositing an outside electrolyte and a protecting coating part enabling to protect the periphery side of said outside electrolyte from a moisture and an air. Therefore, the thread-type flexible battery according to the above-described present invention can be used as battery of necklace cord form of necklace-type PDA, cellular phone and so on, thereby providing an effect enabling to use an instrument by providing a power with necklace cord itself without inserting a battery into said instrument.

### TECHNICAL FIELD

The present invention relates to an optical transmission system, and more particularly, to a ring type optical transmission system having a redundancy structure, which adopts wavelength division multiplexing.

### BACKGROUND ART

Wavelength Division Multiplexing (WDM) is a method in which a Central Office (CO) assigns different wavelengths to individual subscribers and data are simultaneously transmitted. Each subscriber can always transmit or receive data using an assigned wavelength. This method is advantageous in that a large volume of data can be transmitted to each subscriber, the security of communication is excellent and it is easy to improve performance.

Meanwhile, a Passive Optical Network (PON), that is, one of the methods of constructing Fiber-to-the-home (FTTH), is a method in which one Optical Line Termination (OLT) can connect a plurality of Optical Network Units (ONUs) using a passive optical distribution device on a single optical cable. In the PON, data are transmitted from the CO up to a Remote Node (RN) over a single optical fiber, divided by the passive optical distribution device of the RN, and then transmitted to individual subscribers over separate optical fibers. That is, the PON has a configuration in which a CO is connected to an RN installed at a location adjacent to subscribers via a single optical fiber and the RN is connected to individual subscribers via separate optical fibers, so that the cost of cables can be reduced compared to the case where individual optical cables are installed to run all the way from the CO to the subscribers.

A ring type WDM PON system can be implemented by combining the above-described WDM technology and PON technology together. Such a ring type WDM PON system generally adopts a redundancy structure to provide for the cutting of an optical fiber, and the failure of the optical transmission unit or optical reception unit of a certain channel.

An example of the ring type WDM PON system having the redundancy structure is shown in FIG. 1.

The ring type WDM PON system shown in FIG. 1 includes a CO, and a bidirectional optical add/drop multiplexer 120 and redundancy Media Converters (MCs) 130, which are connected to the CO through an optical communication line.

The CO includes general MCs that each have a pair of transmission and reception units TX and RX for converting an electrical signal into an optical signal and outputting the optical signal, and receiving an optical signal having the same wavelength as that of the converted optical signal, converting the received optical signal into an electrical signal and outputting the electrical signal, and a WDM multiplexer/demultiplexer (MUX/DEMUX) 100 that multiplexes optical signals of different wavelengths, which are received from the respective general MCs, and then outputs a multiplexed optical signal to the outside, and demultiplexes a multiplexed signal, which has been received from the outside, and then outputs demultiplexed optical signals to the general MCs. A 3 dB optical coupler is coupled between each of the general MCs of the CO and the MUX/DEMUX 100. The optical coupler also serves as a splitter that distributes optical signals, which are demultiplexed in the MUX/DEMUX 100, to the transmission unit TX and reception unit RX of the general MC.

Meanwhile, a 3 dB optical coupler 110 for dividing an optical signal and transmitting divided signals in opposite directions is connected to the signal output terminal (also signal input terminal) of the CO.

Optical communication lines, which extend in opposite directions and are connected to the optical coupler 110, form a ring type distribution network, as shown in FIG. 1. Bidirectional optical add/drop multiplexers 120, each of which allows signals to normally flow in opposite directions and drops an optical signal of a wavelength corresponding to each subscriber, are disposed at predetermined locations on the ring type distribution network. With the bidirectional optical add/drop multiplexer 120, each RN can transmit optical signals, which are received from subscriber devices, along the ring-type distribution network clockwise or counterclockwise.

Meanwhile, a redundancy MC 130, which detects the cutting of a line and transmits an optical signal only clockwise or counterclockwise, is coupled to each of the bidirectional optical add/drop multiplexers 120. The 3 dB optical coupler is connected between each of the bidirectional optical add/drop multiplexers 120 and each of the two different channels of the redundancy MC 130.

In the ring type WDM PON system having the above-described configuration, the 3 dB optical coupler is coupled in front of the redundancy MC 130. The optical coupler causes a power loss of 3 dB because it divides and outputs a received optical signal. Furthermore, in the ring type optical transmission system, the nodes located in an downstream portion in a signal transmission direction have higher power loss than the nodes located in a upstream portion, so that maintaining constant power at respective nodes is required.

### DESCRIPTION OF DRAWINGS

FIG. 1 is a diagram showing the configuration of a ring type WDM PON system using an optical coupler;

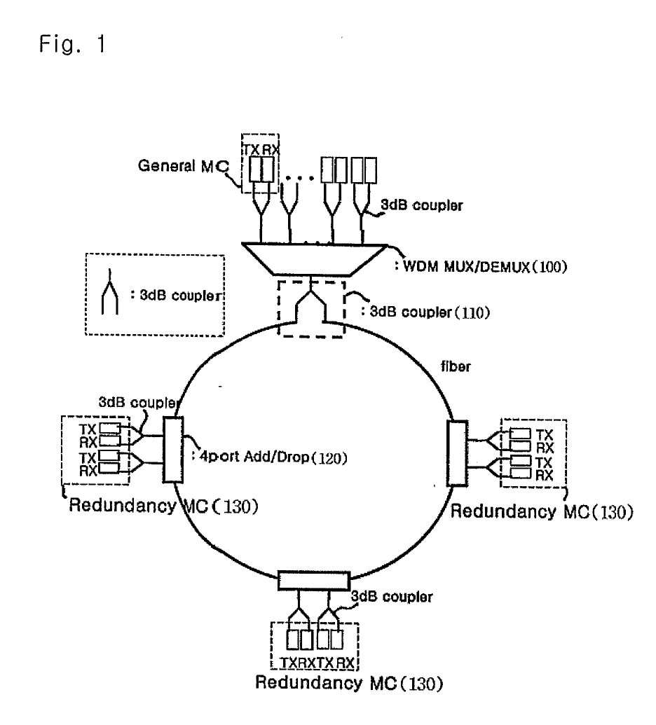

FIG. 2 is a diagram showing the configuration of a ring type optical transmission system according to an embodiment of the present invention;

FIG. 3 is a diagram showing the configuration of a ring type optical transmission system according to another embodiment of the present invention; and

FIG. 4 is a diagram showing the configuration of a ring type optical transmission system according to still another embodiment of the present invention.

### DISCLOSURE

### Technical Problem

An object of the present invention is to provide a ring type optical transmission system having a redundancy structure, which can stabilize system power by compensating for power loss caused by the use of an optical coupler in a ring type optical transmission system.

Another object of the present invention is to provide a ring type optical transmission system having a redundancy structure, which can minimize power loss at nodes located in a downstream portion in a signal transmission direction in a ring type optical transmission system.

### Advantageous Effects

As described above, the present invention is advantageous in that power loss incurred by optical couplers can be prevented because optical circulators are used instead of optical couplers. Furthermore, the optical circulators are employed only at nodes having greater power loss in consideration of an optical signal transmission direction, so that there are advantages in that an increase in system construction cost can be minimized and a system having low power loss can be constructed.

### Best Mode

In order to accomplish the above objects, according to an embodiment of the present invention, the present invention provides a ring type optical transmission system having a CO for generating optical signals of different wavelengths, multiplexing the optical signals and outputting a multiplexed optical signal, an optical coupler for dividing and transmitting the multiplexed optical signal to different communication lines, and one ring type distribution network formed by the different communication lines through a plurality of optical wavelength add/drop multiplexers, wherein a master optical circulator for outputting optical signals, which are dropped by a corresponding optical wavelength add/drop multiplexer, to a first port and outputting an optical signal, which is received from a second port, to the optical wavelength add/drop multiplexer connected thereto, and an slave optical circulator for outputting optical signals, which are dropped by the optical wavelength add/drop multiplexer, to a first port and outputting an optical signal, which is received from a second port, to the optical wavelength add/drop multiplexer connected thereto, are coupled to each of the optical wavelength add/drop multiplexers.

Furthermore, in accordance with another embodiment, the present invention provides a ring type optical transmission system having a CO for generating optical signals of different wavelengths, multiplexing the optical signals and outputting a multiplexed optical signal, an optical coupler for dividing and transmitting the multiplexed optical signal to different communication lines, and one ring type distribution network formed by the different communication lines through a plurality of optical wavelength add/drop multiplexers, wherein master and slave optical couplers having different channels for separately outputting optical signals, which are dropped by a corresponding optical wavelength add/drop multiplexer, to different ports, and outputting an optical signal, which is received from one of the ports, to the optical wavelength add/drop multiplexer connected thereto, are connected to each of the optical wavelength add/drop multiplexers located between downstream portions of a bidirectional transmission path of optical signals divided and transmitted through the first optical coupler, and an optical circulator for outputting optical signals, which are dropped by a corresponding optical wavelength add/drop multiplexer, to a first port and outputting an optical signal, which is received from a second port, to the optical wavelength add/drop multiplexer connected thereto, and an optical coupler for separately outputting optical signals, which are dropped by the optical wavelength add/drop multiplexer, to different ports and outputting an optical signal, which is received from one of the ports, to the optical wavelength add/drop multiplexer connected thereto, are coupled to each of optical wavelength add/drop multiplexers located in the downstream portions of the bidirectional transmission path of optical signals divided and transmitted through the first optical coupler.

### Mode for Invention

Preferred embodiments of the present invention are described in detail below with reference to the accompanying drawings. In the following description of the present invention, when detailed descriptions of known functions or constructions are determined to unnecessarily make the gist of the present invention unclear, the detailed description will be omitted.

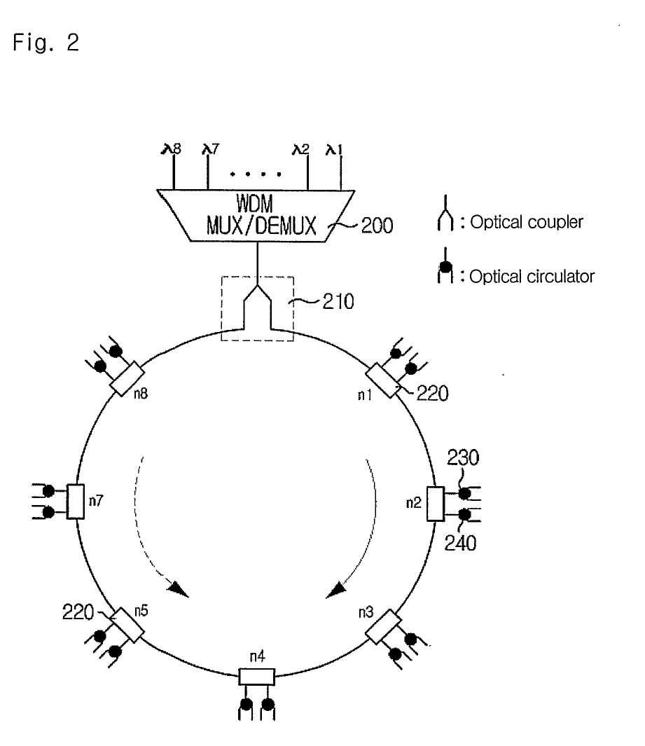

FIG. 2 is a diagram showing the configuration of a ring type optical transmission system, more particularly, a WDM PON system having a redundancy structure according to an embodiment of the present invention.

Referring to FIG. 2, the WDM MUX/DEMUX 200 of a CO functions to multiplex optical signals of different wavelengths, and demultiplex a multiplexed optical signal, which is received through an optical communication line to be described later, for respective wavelengths. Optical signals of different wavelengths are respectively generated by a plurality of optical transmission units, and each of the optical transmission units forms a pair with a corresponding optical reception unit.

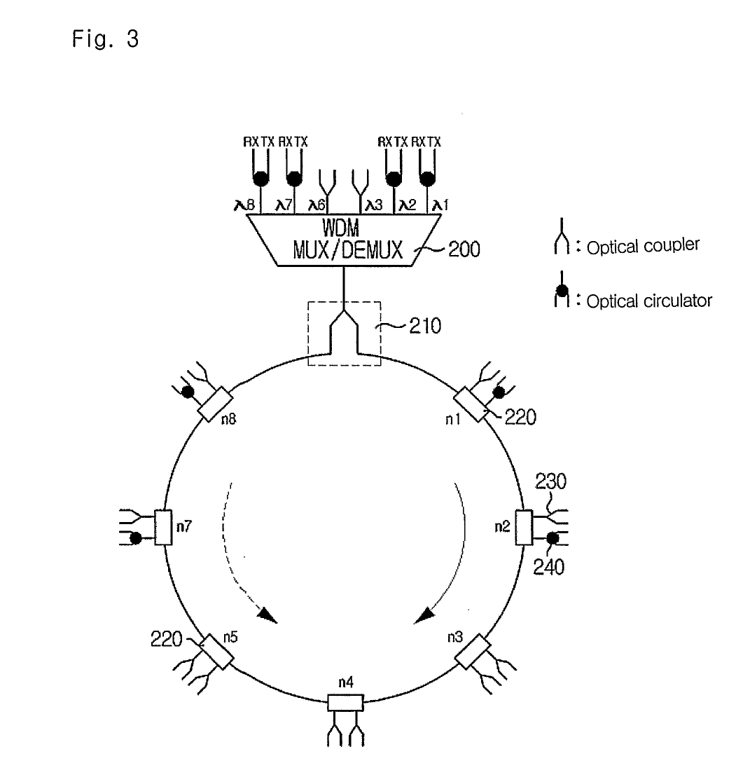

For reference, an optical circulator or optical coupler is coupled and used between each of a pair of optical transmission and reception units TX and RX, which generates optical signals of different wavelengths within the CO and receives such optical signals, and a WDM MUX/DEMUX 200, as shown in FIG. 3.

Meanwhile, an optical coupler 210 functions to divide optical signals of different wavelengths, which are multiplexed in the WDM MUX/DEMUX 200, and then transmit the divided optical signals to different communication lines, and transmit an optical signal, which is output from one of the optical communication lines, to the WDM MUX/DEMUX 200.

The different communication lines coupled to the optical coupler 210 form one ring type distribution network through the optical wavelength add/drop multiplexers 220. The optical wavelength add/drop multiplexers 220 function to drop only signals having wavelengths in a predetermined band from optical signals transmitted through the optical communication lines, and add optical signals, which are output from subscriber devices, to the optical communication lines. For reference, the optical wavelength add/drop multiplexer 220 is also called a node n in the optical transmission system. This optical wavelength add/drop multiplexer 220 is described in detail in a patent application that is entitled “WDM PON System” and was previously filed with the Korean Industrial Property Office by the applicant of the present invention. A detailed description thereof is omitted here.

Meanwhile, a master optical circulator, which outputs an optical signal, dropped by a corresponding optical wavelength add/drop multiplexer, to a first port and outputs an optical signal, received from a second port, to an optical wavelength add/drop multiplexer 220 connected thereto, and a slave optical circulator, which outputs an optical signal, dropped by the optical wavelength add/drop multiplexer 220, to a first port and outputs an optical signal, received from a second port, to an optical wavelength add/drop multiplexer 220 connected thereto, are coupled to each of the optical wavelength add/drop multiplexers 220.

As an example, the first and second ports of the master optical circulator are connected to a master optical reception unit and a master optical transmission unit within the redundancy MC, respectively. The first and second ports of the slave optical circulator are also connected to a slave optical reception unit and a slave optical transmission unit within the redundancy MC, respectively.

In the optical transmission system having the above-described construction, power loss depending upon the movement of an optical signal is examined below. Optical signals output through the WDM MUX/DEMUX 200 of the CO are transmitted to the optical wavelength add/drop multiplexers 220 through the optical communication Lines. Only optical signals having wavelengths in a predetermined band are dropped by each of the optical wavelength add/drop multiplexers 220, and are applied to the redundancy MC through the optical circulator of a master channel.

In this case, the optical circulator entails a small amount of power loss (about 1 dB) compared to an optical coupler, so that it is possible to construct a system having low power loss compared to a system employing optical couplers.

However, in the case where a ring type optical transmission system having a redundancy structure is constructed using only optical circulators as shown in FIG. 2, there is an disadvantage in that the system construction cost increases. This is because the price of an optical circulator is higher than that of an optical coupler.

Therefore, it is necessary to design a system structure having low power loss while minimizing the increase of the system construction cost. The structure of such a system is shown in FIG. 3.

FIG. 3 is a diagram showing the configuration of a ring type optical transmission system according to another embodiment of the present invention. This ring type optical transmission system also includes a WDM MUX/DEMUX 200 that generates optical signals of different wavelengths, multiplexes the optical signals and outputs the multiplexed optical signal, and an optical coupler 210 that divides a multiplexed optical signal into different communication lines. Further, the different communication lines connected to the optical coupler 210 form a ring type distribution network through a plurality of optical wavelength add/drop multiplexers.

Meanwhile, master and slave optical couplers having different channels, which separately output optical signals dropped by a corresponding optical wavelength add/drop multiplexer to different ports, and output an optical signal received from any of the ports to the optical wavelength add/drop multiplexer connected thereto, are connected to each of optical wavelength add/drop multiplexers n3, n4 and n5 located between the downstream portions of the bidirectional (clockwise and counterclockwise) transmission path of optical signals. An optical circulator, which outputs optical signals, dropped by a corresponding optical wavelength add/drop multiplexer, to a first port and outputs an optical signal, received from a second port, to the optical wavelength add/drop multiplexer connected thereto, and an optical coupler, which separately outputs optical signals, dropped by the optical wavelength add/drop multiplexer, to different ports and outputs an optical signal, received from one of the ports, to the optical wavelength add/drop multiplexer connected thereto, are connected to each of optical wavelength add/drop multiplexers n7 n8, n2 and n1 located in the downstream portions of the bidirectional transmission path of optical signals.

In that case, it is to be noted that the optical circulators that are coupled to the optical wavelength add/drop multiplexers n7 and n8 located in the downstream portion of the clockwise transmission path of the bidirectional transmission path must be coupled to master channel sides, and the optical circulators that are coupled to the optical wavelength add/drop multiplexers n1 and n2 located in the downstream portion of the counterclockwise transmission path of the bidirectional transmission path must be coupled to slave channel sides.

The reason for this is that, if an optical signal is transmitted clockwise, the nodes n7 and n8 have much higher power loss than do upstream nodes in light of both power loss caused by the use of the optical coupler and power loss incurred by the upstream nodes themselves.

Accordingly, higher power loss at the nodes n7 and n8 than that at other nodes can be compensated for to some degree by substituting the optical couplers of the master channels with optical circulators at the nodes n7 and n8.

In the same manner, an optical signal can be transmitted counterclockwise, so that power loss at the downstream portion of the transmission path of the optical signal can be compensated for by substituting the optical couplers of the slave channels with optical circulators at the nodes n1 and n2 in consideration of the above-described problem.

Furthermore, the power loss of the system can be further reduced by adopting optical circulators between the optical transmission and reception units of the CO, which generate the optical signals of different wavelengths that are dropped by the optical wavelength add/drop multiplexers n1, n2, n7 and n8 to which the optical circulators are coupled, and the WDM MUX/DEMUX 200.

As described above, by disposing the optical circulators in the downstream portions of the bidirectional transmission path of optical signals and the optical couplers at the nodes located between the downstream portions, a system structure having low power loss as well as minimally increased system construction cost can be designed.

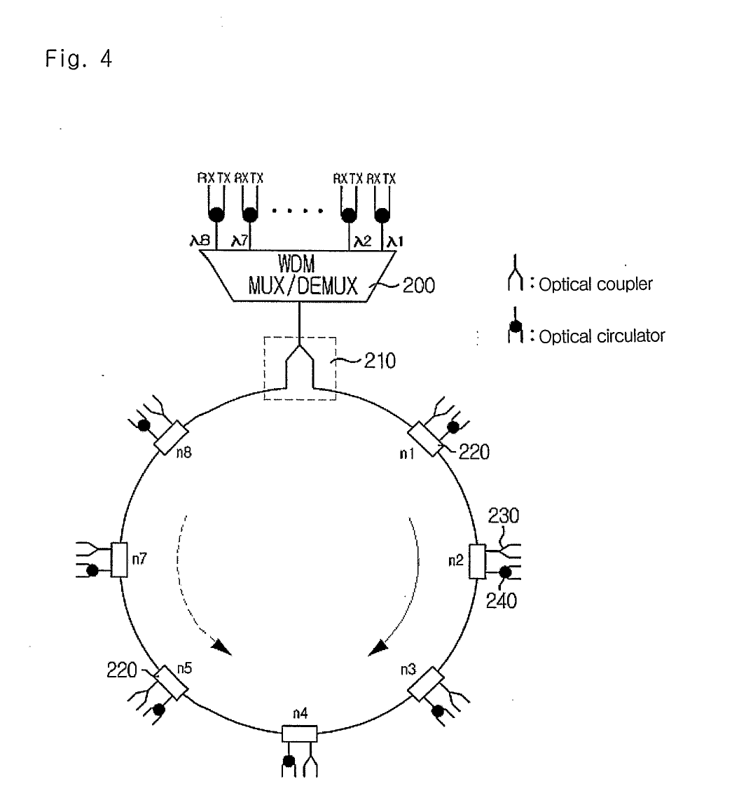

FIG. 4 is a diagram showing the configuration of a ring type optical transmission system according to still another embodiment of the present invention. The ring type optical transmission system has a structure in which a master optical circulator and a slave optical coupler are connected to each of optical wavelength add/drop multiplexers n1 to n8.

The master optical circulator functions to allow optical signals to be applied to the master optical reception unit of a redundancy MC by outputting the optical signals, which are dropped by a corresponding optical wavelength add/drop multiplexer, to a first port, and receive an optical signal, which is generated by a master optical transmission unit, through a second port and then output the optical signal to the optical wavelength add/drop multiplexer connected thereto.

Meanwhile, the slave optical coupler functions to allow optical signals to be applied to the slave optical reception unit of the redundancy MC by separately outputting optical signals, which are dropped by a corresponding optical wavelength add/drop multiplexer, to different ports, and receive an optical signal, which is generated by a slave optical transmission unit through one of the ports, and then output the received optical signal to the optical wavelength add/drop multiplexer connected thereto.

As described above, by coupling one optical circulator and one optical coupler to each of optical wavelength add/drop multiplexers, a system structure having low power loss as well as minimally increased system construction cost can be designed.

Furthermore, in order to facilitate the construction, a system can be constructed simply by coupling optical circulators only to the master channels of all nodes, or by coupling optical circulators only to the slave channels of all nodes.

1. A ring type optical transmission system having a Central Office (CO) for generating optical signals of different wavelengths, multiplexing the optical signals and outputting a multiplexed optical signal, an optical coupler for dividing and transmitting the multiplexed optical signal to different communication lines, and one ring type distribution network formed by the different communication lines through a plurality of optical wavelength add/drop multiplexers,
wherein a master optical circulator for outputting optical signals, which are dropped by a corresponding optical wavelength add/drop multiplexer, to a first port and outputting an optical signal, which is received from a second port, to the optical wavelength add/drop multiplexer connected thereto, and an slave optical circulator for outputting optical signals, which are dropped by the optical wavelength add/drop multiplexer, to a first port and outputting an optical signal, which is received from a second port, to the optical wavelength add/drop multiplexer connected thereto, are coupled to each of the optical wavelength add/drop multiplexers.

2. A ring type optical transmission system having a CO for generating optical signals of different wavelengths, multiplexing the optical signals and outputting a multiplexed optical signal, an optical coupler for dividing and transmitting the multiplexed optical signal to different communication lines, and one ring type distribution network formed by the different communication lines through a plurality of optical wavelength add/drop multiplexers,
wherein a master optical circulator for outputting optical signals, which are dropped by a corresponding optical wavelength add/drop multiplexer, to a first port and outputting an optical signal, which is received from a second port, to the optical wavelength add/drop multiplexer connected thereto, and a slave optical coupler for separately outputting optical signals, which are dropped by the optical wavelength add/drop multiplexer, to different ports and outputting an optical signal, which is received from one of the ports, to the optical wavelength add/drop multiplexer connected thereto, are coupled to each of the optical wavelength add/drop multiplexers.

3. A ring type optical transmission system having a CO for generating optical signals of different wavelengths, multiplexing the optical signals and outputting a multiplexed optical signal, an optical coupler for dividing and transmitting the multiplexed optical signal to different communication lines, and one ring type distribution network formed by the different communication lines through a plurality of optical wavelength add/drop multiplexers, wherein:
master and slave optical couplers having different channels for separately outputting optical signals, which are dropped by a corresponding optical wavelength add/drop multiplexer, to different ports, and outputting an optical signal, which is received from one of the ports, to the optical wavelength add/drop multiplexer connected thereto, are connected to each of the optical wavelength add/drop multiplexers located between downstream portions of a bidirectional transmission path of optical signals divided and transmitted through the first optical coupler, and
an optical circulator for outputting optical signals, which are dropped by a corresponding optical wavelength add/drop multiplexer, to a first port and outputting an optical signal, which is received from a second port, to the optical wavelength add/drop multiplexer connected thereto, and an optical coupler for separately outputting optical signals, which are dropped by the optical wavelength add/drop multiplexer, to different ports and outputting an optical signal, which is received from one of the ports, to the optical wavelength add/drop multiplexer connected thereto, are coupled to each of optical wavelength add/drop multiplexers located in the downstream portions of the bidirectional transmission path of optical signals divided and transmitted through the first optical coupler.

4. The ring type optical transmission system according to claim 3, further comprising optical circulators between optical transmission and reception units of the CO, which generate the optical signals of wavelengths that are dropped by the optical wavelength add/drop multiplexers to which the optical circulators are coupled, and a Wavelength Division Multiplexing (WDM) Multiplexer (MUX)/Demultiplexer (DEMUX).

5. The ring type optical transmission system according to claim 3 or 4, wherein the optical circulators coupled to optical wavelength add/drop multiplexers located in the downstream portion of a clockwise transmission path of the bidirectional transmission path are coupled to master channels, respectively, and the optical circulators coupled to optical wavelength add/drop multiplexers located in the downstream portion of a counterclockwise transmission path of the bidirectional transmission path are coupled to slave channels, respectively.
